(19) United States
(12) Patent Application Publication
(10) Pub. No.: US 2002/0103830 A1
(43) Pub. Date: Aug. 1, 2002

(54) Method for controlling the presentation of multimedia content on an internet web page

(76) Inventors: Fabrice C. Hamaide, Palo Alto, CA (US); Douglas Z. Pan, Milpitas, CA (US); Plamen Parvanov, Hayward, CA (US)

Correspondence Address: Richard E. Bee, Weinberg Legal Group, Suite 250, 2390 East Camelback Road, Phoenix, AZ, 85016, US

(21) Appl. No.: 09/773,109

(22) Filed: Jan. 31, 2001

(51) Int. Cl. G09G 5/12

(52) U.S. Cl. 707/513; 707/500.1

(57) ABSTRACT

Improved methods for controlling the presentation of multimedia content on a web page are provided. Such methods include detecting the occurrence of a particular event or a combination of events with respect to a web page. An event trigger indicative of the detected event or combination of events is generated. This event trigger is used to select a multimedia player and the multimedia content to be played by the selected player. The selected multimedia player is loaded with the selected content and the playing of the selected player is launched to provide a desired multimedia presentation on the web page.

### TECHNICAL FIELD

This invention relates to Internet web pages and to methods for determining the information displayed on Internet web pages.

### BACKGROUND OF THE INVENTION

As the Internet World Wide Web matures, web site managers are deploying greater amounts of multimedia content on their web pages. However, there are a number of obstacles preventing widespread adoption of these technologies in some applications. For instance, the multimedia player and the content to be played are typically determined at the time the web page is downloaded. This limitation does not allow the player or the content in the page to be selected dynamically after the page is downloaded, based on user actions within the page or on timing or other system characteristics. A number of important new applications would benefit if this functionality were available.

For another thing, downloading the multimedia content shares network bandwidth with the downloading of the web page itself, resulting in a significantly slower web surfing experience for the end users. These factors have discouraged both large web sites and large advertising networks from deploying multimedia advertising and other multimedia materials as part of Internet web pages.

### SUMMARY OF THE INVENTION

The present invention provides an improved method for presenting multimedia content on an Internet web page. This improved method includes detecting the occurrence of a particular event or a combination of events with respect to a web page. This improved method further includes using such detection to select and initiate a multimedia presentation on the web page.

For a better understanding of the present invention, together with other and further advantages and features thereof, reference is made to the following description taken in connection with the accompanying drawings, the scope of the invention being pointed out in the appended claims.

### BRIEF DESCRIPTION OF THE DRAWINGS

Referring to the drawings:

FIG. 1 is a flowchart of an initial part of a method using the present invention;

FIG. 2 is a block diagram showing the basic idea behind a generateEvent( ) routine used in the present invention;

FIG. 3 is a flowchart for the generateEvent( ) routine of FIG. 2;

FIG. 4 is a flowchart for a display( ) routine used in the present invention;

FIG. 5 shows a first method for implementing the load and launch step of FIG. 4;

FIG. 6 shows a second method for implementing the load and launch step of FIG. 4;

FIG. 7 shows a third method for implementing the load and launch step of FIG. 4;

FIG. 8 shows a further method for implementing the load and launch step of FIG. 4;

FIG. 9 is a flowchart for a multimedia player initiate sequence used in the present invention;

FIGS. 10 and 11 are timing diagrams used in explaining an application of the present invention;

FIGS. 12 and 13 are screen shots used in explaining an application of the present invention;

FIGS. 14-16 are screen shots used in explaining a further application of the present invention; and

FIG. 17 is a schematic diagram of typical hardware used in practicing the present invention.

### DETAILED DESCRIPTION OF THE ILLUSTRATED EMBODIMENTS

The present invention provides a method for delaying and/or selecting a multimedia player software program and the multimedia content to be played by that player software on an Internet web page. Such delay and/or selection is based on events that occur within the web page under consideration or a related web page or on system events otherwise accessible (for example, through JavaScript code). Multimedia content includes audio, video, animation, slide shows, etc. The uniqueness of the invention stems from the mechanism used to determine the parameters used for the display of the multimedia content. These parameters include: (a) when the content starts playing; (b) what player software is used to play the content; and (c) what content is played. Traditionally, these parameters are defined by the static content of the web page itself (for example, the web page contains the URL of the content to be played). With the present invention, on the other hand, these parameters may be dynamically determined after the web page has been loaded, based on events that happen on that page or a related page.

The invention may be implemented using a computer programming language, such as JavaScript, that is embedded in or accessible from a web page. For sake of example in this description, reference will be made to the use of JavaScript, but it should be understood that another computer language could be used.

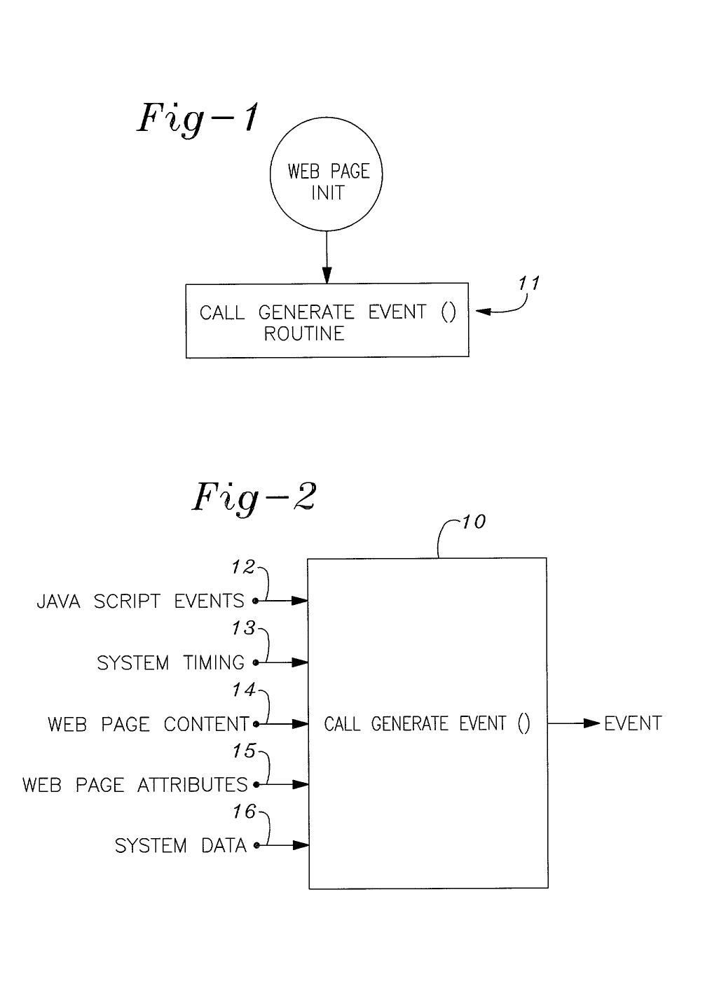

A flowchart outlining the JavaScript code that would be embedded in a web page is shown in FIGS. 1 and 3-9. When the web browser loads the web page, the web page initiate sequence of FIG. 1 is initiated. In this sequence, the generateEvent( ) routine 10 is called, as indicated at step 11. This routine will ultimately generate an event trigger that causes a multimedia player to be selected and launched and causes a clip of multimedia content to be chosen and played by the selected player. The basic idea behind this routine 10 is displayed in FIG. 2. The purpose of routine 10 is to generate an event trigger to start the display of the multimedia content when the conditions specified by the page designer have been met. The generateEvent( ) routine 10 sets itself up to receive JavaScript events 12, system timing information 13, web page content 14, web page attributes 15 and other system data 16. The specific information received could be limited to that information necessary to trigger an event at the time the designer wants the multimedia content to appear. The event could be the same as a standard JavaScript event, such as onLoad, or could be a composite event, which is any combination and sequence of events, timing and data that can be expressed and tracked by JavaScript code.

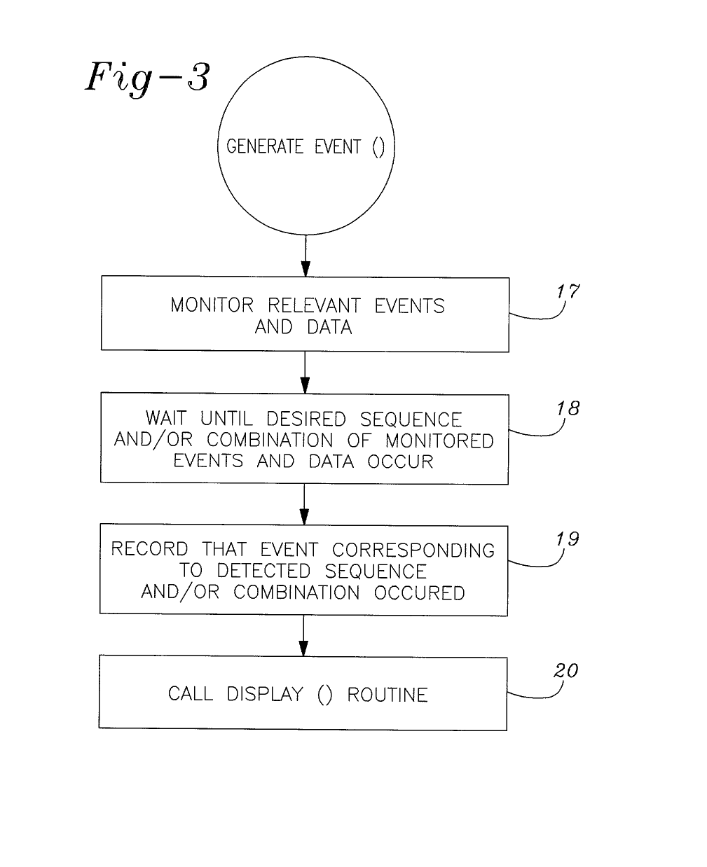

When the generateEvent( ) routine is called, the sequence of steps shown in the flowchart of FIG. 3 is initiated. This routine sets itself up to run asynchronously to avoid blocking any other routines that may be running at the same time. This routine first receives (step 17) the information necessary to determine when it should generate the event. This information includes everything accessible using the JavaScript language, such as JavaScript events, system timing information, system data, web page content, web page attributes, browser attributes, etc. Next, the routine waits (step 18) until the desired sequence and/or combination of this information occurs. Once it occurs, an event corresponding to that sequence and/or combination is said to have occurred. The routine optionally records (step 19) that the event occurred. Then, it calls (step 20) the display( ) routine.

When display( ) is called, the display( ) sequence of steps shown in the flowchart of FIG. 4 is initiated. This routine selects (step 21) the multimedia player software to be used and the multimedia content to be played. This selection could depend on the event, or could be specified by the event itself as a parameter. Then, the display( ) routine would load and launch (step 22) the multimedia player software.

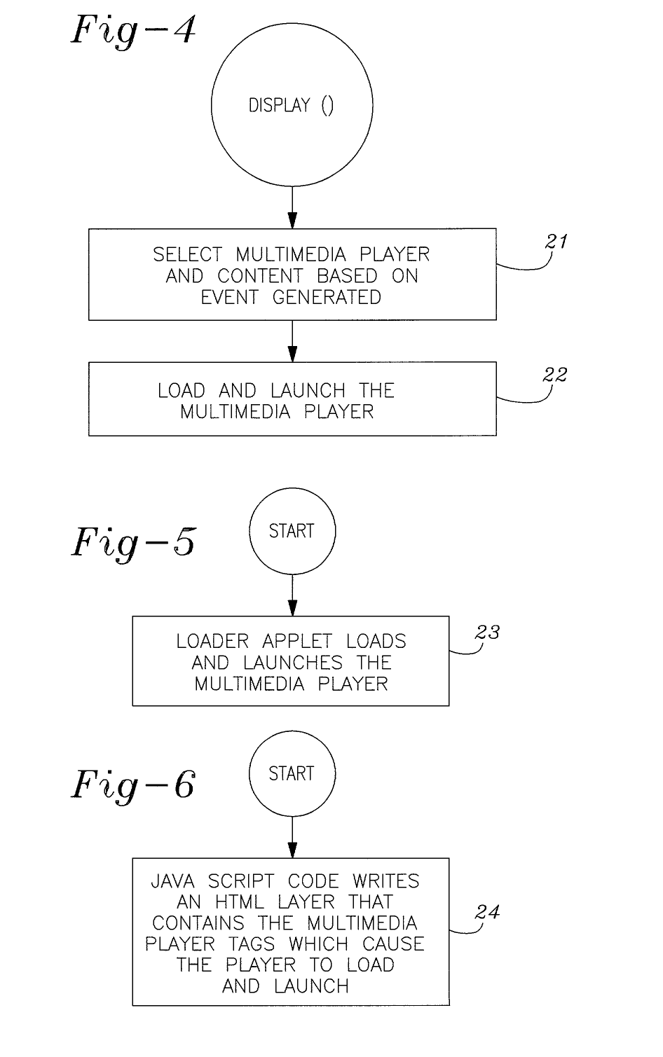

There are several different ways of implementing the final step 22 (the load and launch step) of the display( ) routine of FIG. 4. Three of these implementations are shown in FIGS. 5, 6 and 7. As shown in FIG. 5 at step 23, a first method makes use of a small loader applet which loads and launches the multimedia player. This loader applet is a tiny Java applet which is separate from the multimedia player. The sole purpose of this small loader applet is to wait until the event is triggered and then to load and start the multimedia player.

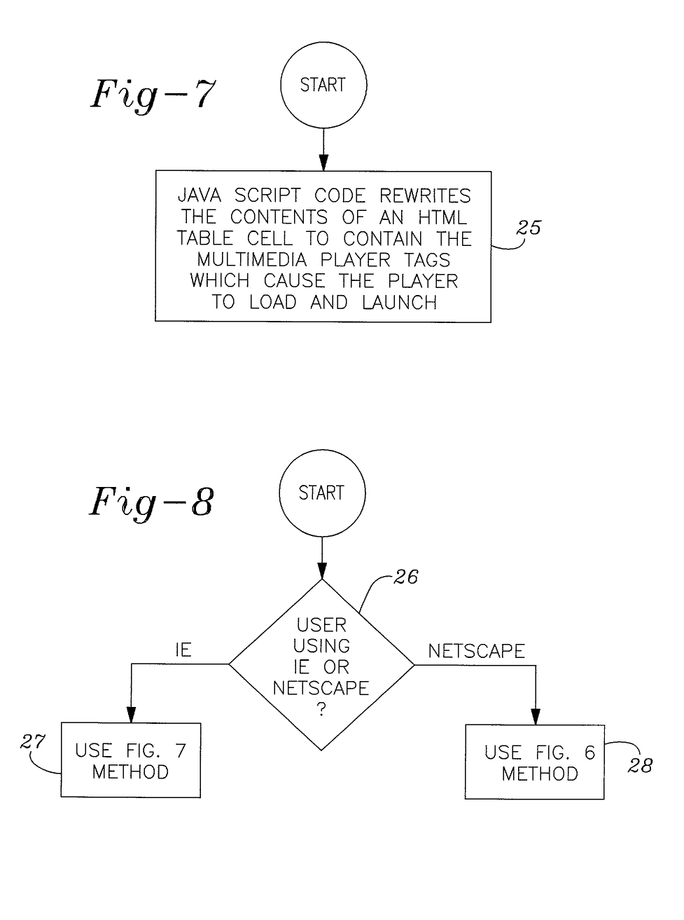

A second load and launch method is shown at step 24 in FIG. 6. In this method, JavaScript code writes an HTML layer that contains the HTML tags for the multimedia player. This causes the player to load and launch.

FIG. 7 shows a third load and launch method. In this third method, JavaScript code rewrites the contents of an HTML table cell to contain the HTML tags for the multimedia player which cause the player to load and launch.

FIG. 8 shows that different implementations can be selected, depending on the user's computing environment. In this example, decision block 26 decides which of two web browsers is being used. If an Internet Explorer (IE) browser is being used, then, as indicated at step 27, the FIG. 7 method is used to load and launch the player. If, on the other hand, a Netscape browser is being used, then the FIG. 6 method is used to load and launch the player, this being shown at step 28. The FIG. 8 technique is useful because some implementations may not achieve the desired effect on some computer platforms.

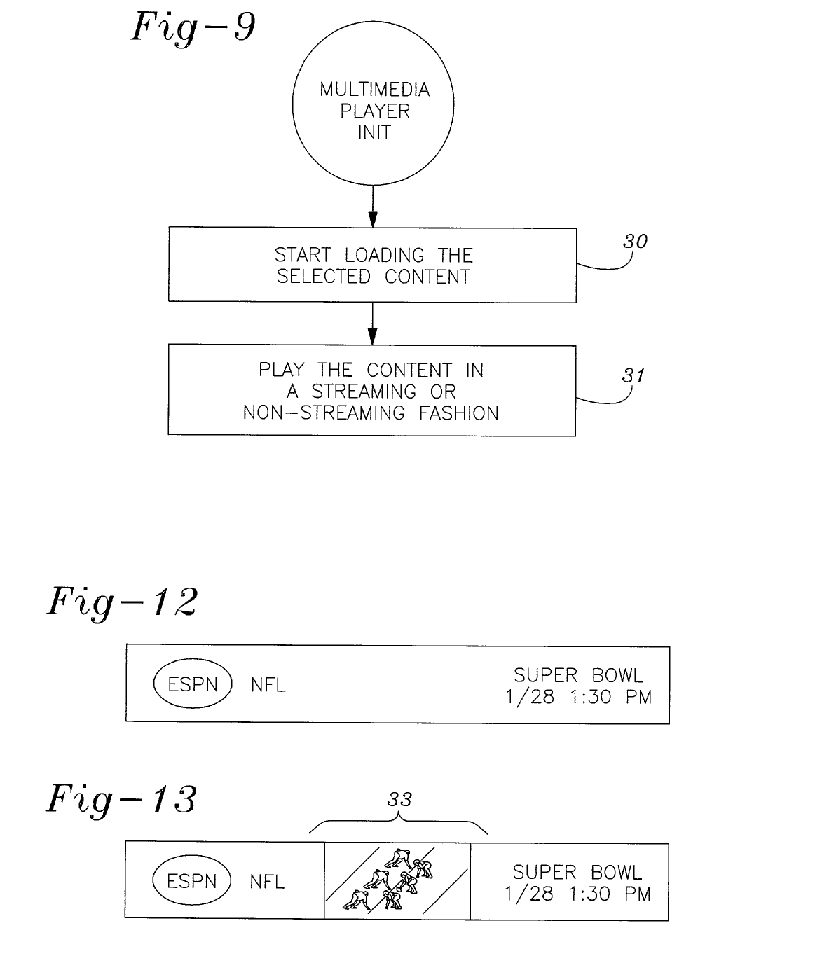

As the multimedia player is initialized, the multimedia player init·sequence shown in the flowchart of FIG. 9 takes place. As indicated at step 30, the player begins to load the previously selected content. Alternatively, it could make the selection of content based on information passed to it by the display( ) routine. As indicated at step 31, the player would then play the content, either in a streaming fashion, in which the content begins playing before it has been completely downloaded to the client machine, or in a non-streaming fashion, in which the content does not begin playing until it has been completely downloaded to the client machine.

Several specific applications of the present invention will now be considered. The first application will be the deployment of multimedia content in an advertising banner. The traditional way of doing this would involve the following steps:

1. The web browser loads the web page and its static content.

2. The web browser loads the multimedia player software.

3. The multimedia player loads the multimedia content and plays it for the advertising banner.

In a typical browser environment, steps 1 and 2 proceed concurrently, with the result that step 1 proceeds slower than it would have if there had been no multimedia content to be played. Downloading the player software and multimedia content shares network bandwidth with the downloading of the web page and, thus, slows down the downloading of the web page. This is the slowdown that has prevented multimedia content from being widely used in banner ads on the Internet. The present invention solves this problem by delaying the start of steps 2 and 3 until after step 1 has been completed. As a result, the web page and its static content is loaded with the same speed as would have been the case without the multimedia material. Thus, to the viewer, there is no noticeable slowdown to the downloading of the web page. There is, of course, a delay in the start of the multimedia segment of the advertising banner, but, as far as the viewer is concerned, this would appear to be an intentional delay of the multimedia content for dramatic effect. Also, during this delay, a static or animated image may be displayed in the screen area that will eventually be occupied by the multimedia content. This allows the banner area to appear to the user as a normal banner ad before the multimedia content begins.

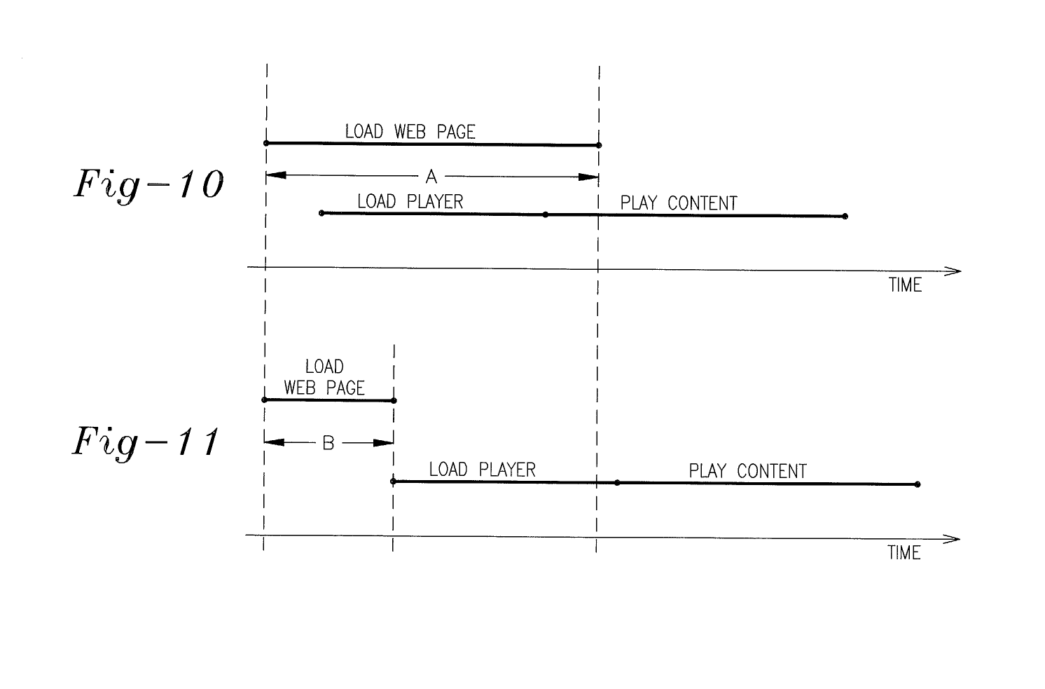

FIG. 10 is a timing diagram for the traditional method and FIG. 11 is a corresponding timing diagram for the improved method of the present invention. As seen in FIG. 11, the loading of the multimedia player and the playing of the multimedia content is delayed until the loading of the web page is completed. As further seen, the time interval B for loading the web page with the present invention is much smaller than the time interval A for loading the web page using the traditional method.

FIG. 12 is a screen shot of a typical banner ad of the type typically displayed across the top of a web page. FIG. 13 shows the same banner ad but with the addition of a video clip of a football game in the middle portion 33 of the banner ad.

The key to the implementation of the FIG. 11 method is to build a mechanism that delays step 2 until after step 1 is complete. This delay can be accomplished using the present invention. To do this, the generateEvent( ) routine in FIG. 3 would wait (step 18) until the JavaScript onLoad event occurs, which happens when the web page has completed downloading, that is, at the end of step 1. A specific approach for then displaying the multimedia content is as shown in FIGS. 4 and 8. As a result of these methods, the downloading of the web page is not made slower by the downloading of the multimedia advertisement.

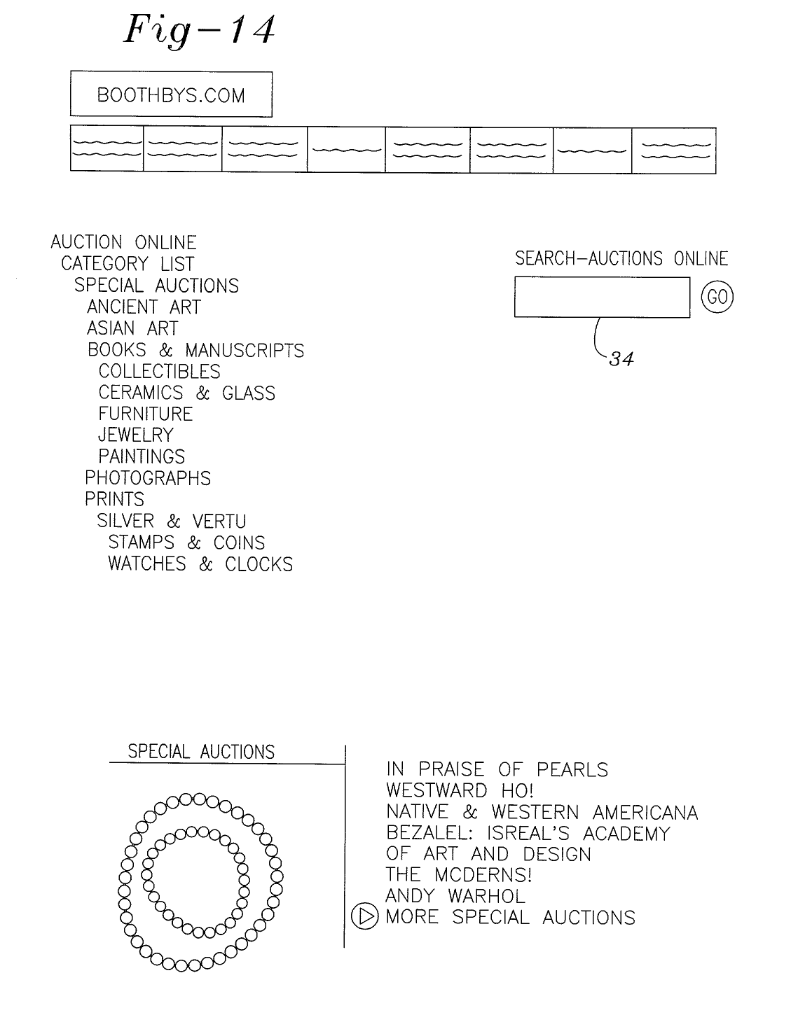

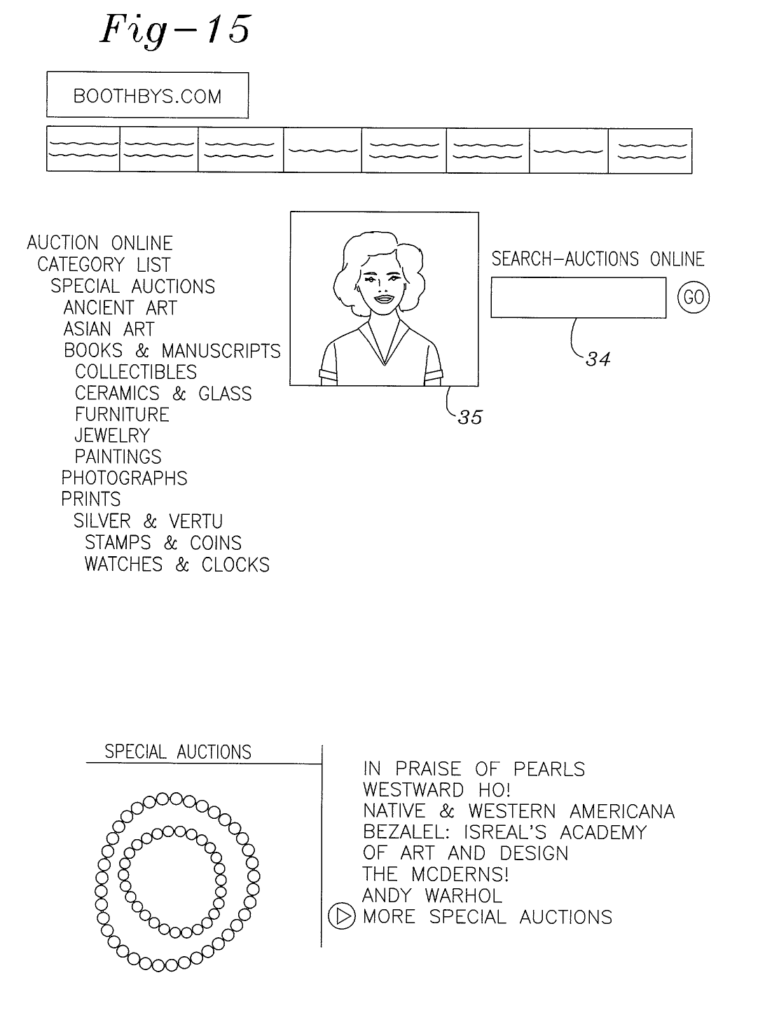

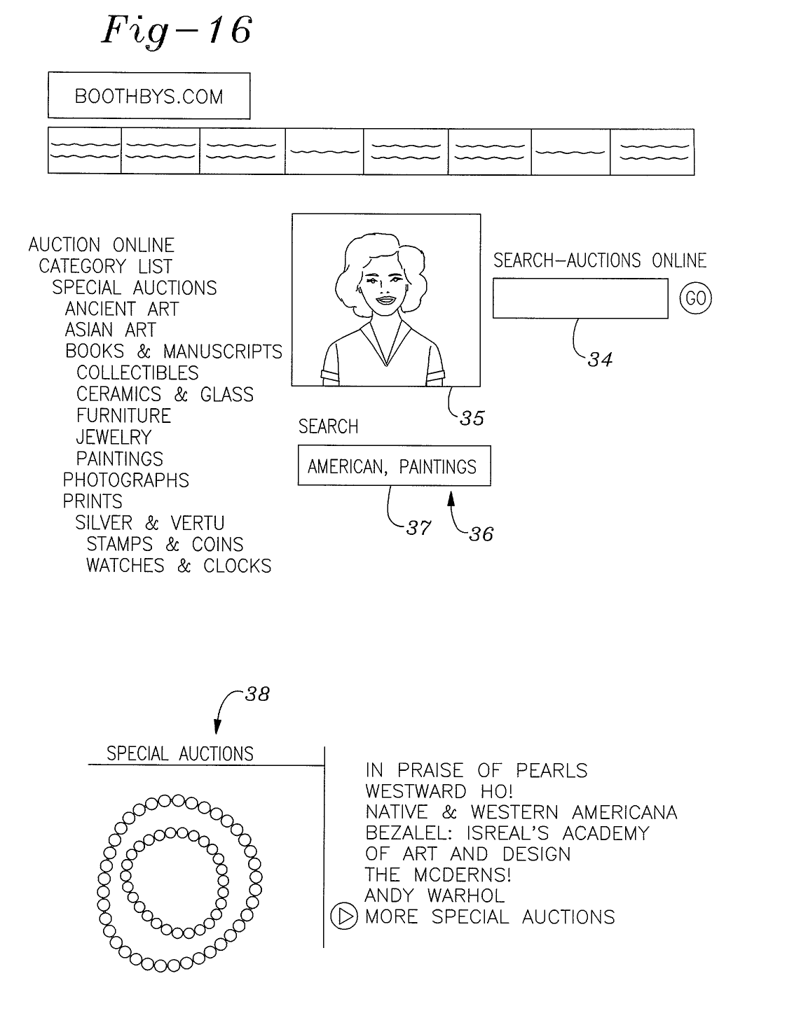

Another possible application of the present invention is shown in the screen shots of FIGS. 14-16. This is a customer support type of application. FIG. 14 shows an auction web site with a search box 34 near the upper right-hand corner. If the user clicks his mouse in the search box 34, an audio/video presentation 35 immediately appears to the left of the search box 34 with helpful search tips and hints. This is shown in FIG. 15. FIG. 16 shows that video content 35 can be combined with animation content 36 by showing a sample search box 37 as part of the video.

In the FIGS. 14-16 example, the generateEvent( ) function previously mentioned takes the form of passing through the normal JavaScript onFocus event for the search text input box 34. In this example, the selection of the multimedia player is not done dynamically. Instead, it is set to a constant value specified in the web page. For loading and launching the multimedia player, the solution shown in FIG. 8 is used.

This example could be extended by having different videos play, depending on what the user does. For instance, the previous video could play if the user clicks in the search box 34, but a different video could play if the user mouses over or clicks on the “Special Auctions” heading or image 38. In this case, the generateEvent( ) function would generate different events, depending on whether the user action was on the search box 34 or the Special Auctions heading 38. The selection of the multimedia content would be done dynamically, based on the event that is generated.

As a further application of the present invention, consider the example of a web page for a multimedia store which sells video tapes, video DVD's and music CD's. For the video items, a small image or line of text could identify each item for sale, clustered around a video viewing area. As the user mouses over or clicks on the image or text for a video item, a video player would show a movie trailer for that particular item in the video viewing area. Or, if the user mouses over or clicks on the image or text for a music CD, an audio player instead of a video player would be selected to play the hit song from that CD.

This audio/video store example demonstrates multiple events being generated, depending on the item the user mouses over or clicks on. This example also demonstrates how different multimedia players can be selected, in this case, a video player for video tapes and an audio player for music CD's. Additionally, this example demonstrates the selection of different content based on different user actions. For example, different movie trailers are shown depending on the particular video item the user mouses over or clicks on.

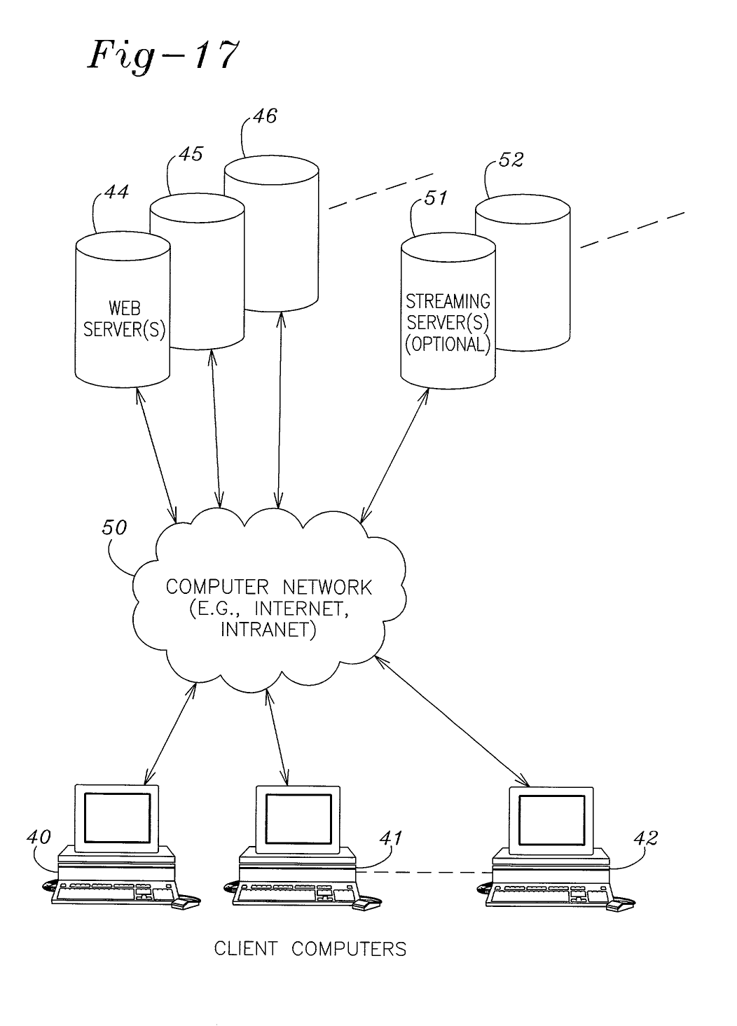

FIG. 17 shows typical hardware that is used in practicing the present invention. Various user or client computers 40, 41, 42, etc. are connected to a plurality of web servers 44, 45, 46, etc. by means of a computer network 50 which may be, for example, the popular Internet. The web pages are maintained in the web servers 44-46 and are downloaded to user computers 40, 41, 42, etc. by means of the Internet 50. Streaming material may be stored on separate servers 51 and 52.

While there have been described what are at present considered to be preferred embodiments of this invention, it will be obvious to those skilled in the art that various changes and modifications may be made therein without departing from the invention and it is, therefore, intended to cover all such changes and modifications as come within the true spirit and scope of the invention.

What is claimed is:

1. A method for controlling the presentation of multimedia content on a web page, such method comprising:
detecting the occurrence of a particular event or a combination or sequence of events with respect to a web page;
and using such detection to select and initiate a multimedia presentation on the web page.

2. A method for controlling the presentation of multimedia content on a web page, such method comprising:
detecting the occurrence of a particular event or a combination of events with respect to a web page;
generating an event trigger corresponding to the detected event or combination of events;
selecting a multimedia player and content based on the generated event trigger;
and loading the selected multimedia player with the selected content and launching the playing of the selected player to provide a multimedia presentation on the web page.

3. A method in accordance with claim 2 wherein the detected event is the completion of the loading of the web page and its static content and the selecting and loading of the multimedia player is accomplished by a small loader applet which is activated after the loading of the web page is completed.

4. A method in accordance with claim 3 wherein the detected event is the occurrence of a JavaScript onLoad command.

5. A method in accordance with claim 2 wherein the selecting and loading of the multimedia player is accomplished by writing an HTML layer that contains the multimedia player tags needed to load and launch the player.

6. A method in accordance with claim 2 wherein the selecting and loading of the multimedia player is accomplished by rewriting the contents of an HTML table cell to contain the multimedia player tags needed to load and launch the player.

7. A method in accordance with claim 2 wherein a first method of loading and launching the multimedia player is used when the web browser is of a first type and a second method of loading and launching the multimedia player is used when the web browser is of a second type.

8. A method in accordance with claim 2 wherein the loading and launching of the multimedia player is accomplished by writing an HTML layer that contains the tags needed for this purpose when the web browser is a Netscape browser and the loading and launching of the multimedia player is accomplished by rewriting the contents of an HTML table cell to contain the tags needed for this purpose when the web browser is an Internet Explorer browser.

9. A method in accordance with claim 2 wherein a first method of loading and launching the multimedia player is used when the web client environment is of a first type and a second method of loading and launching the multimedia player is used when the web client environment is of a second type, where a web client environment is a particular combination of browser software, computer hardware and computer operating system.

10. A method of presenting multimedia content on a web page, such method comprising:
first loading the web page and its static content;
and loading and playing the multimedia content after completion of the loading of the web page and its static content.

11. A method of presenting multimedia content on a web page, such method comprising:
first completely loading the web page and its static content;
thereafter loading a multimedia player;
and thereafter loading the multimedia content into the multimedia player and playing the player to present the multimedia content on the web page.

12. A method for controlling the presentation of multimedia content on a web page, such method comprising:
loading a web page and its static content, such static content including a user selectable image;
detecting the occurrence of a user click on or mouse movement over the selectable image;
and using such detection of a user click or mouse over to initiate the occurrence of a multimedia presentation on the web page.

13. A method in accordance with claim 12 wherein the user selectable image is a button.

14. A method in accordance with claim 12 wherein the user selectable image is a link.

15. A method in accordance with claim 12 wherein the user selectable image is a selection box.

16. A method in accordance with claim 12 wherein the user selectable image is a search box and the multimedia presentation provides helpful search tips and hints.

17. A method for controlling the presentation of multimedia content on a web page, such method comprising:
loading a web page and its static content, such static content including a plurality of user selectable images;
detecting the occurrences of user clicks on or mouse movements over different ones of the user selectable images;
and using such detections to initiate the occurrences of different multimedia presentations on the web page.

18. A method for controlling the presentation of multimedia content on a web page having movie related images and music related images, such method comprising:
loading a web page and its static content, such static content including a set of movie related images and a set of music related images;
detecting the occurrence of a user click on or mouse movement over one of the movie related images;
using such detection of a user click on or mouse over a movie related image to initiate the appearance of a video presentation on the web page;
detecting the occurrence of a user click on or mouse movement over one of the music related images;
and using such detection of a user click on or mouse over a music related image to initiate the occurrence of an audio presentation for the web page.
